(19) United States
(12) Patent Application Publication
(10) Pub. No.: US 2024/0381150 A1
(43) Pub. Date: Nov. 14, 2024

(54) RRM MEASUREMENT WITH LP-WUS

(71) Applicant: APPLE INC., Cupertino, CA (US)

(72) Inventors: Fangli Xu, Beijing (CN); Haijing Hu, Los Gatos, CA (US); Naveen Kumar R Palle Venkata, San Diego, CA (US); Yuqin Chen, Beijing (CN); Sigen Ye, San Diego, CA (US); Peng Cheng, Beijing (CN); Zhibin Wu, Los Altos, CA (US); Alexander Sirotkin, Hod Hasharon (IL); Ping-Heng Kuo, London (GB); Ralf Rossbach, Munich (DE)

(21) Appl. No.: 18/658,297

(22) Filed: May 8, 2024

Related U.S. Application Data
(60) Provisional application No. 63/501,542, filed on May 11, 2023.

(51) Int. Cl. H04W 24/10; H04B 7/06; H04L 5/00; H04W 52/02; H04W 56/00

(52) U.S. Cl. CPC H04W 24/10; H04B 7/0626; H04L 5/0051; H04W 52/0235; H04W 56/0015

(57) ABSTRACT

A UE may coordinate the use of a low Power Wake-Up Radio (LR) and a main radio (MR) to determine a Radio Resource Management (RRM) measurement. The UE may enter a deep sleep state by turning off a MR and turning on a LR. The UE may measure the serving cell quality when in the deep sleep state, and enter a normal state by turning on the MR, when the serving cell quality is less than a threshold. The UE may perform a neighbor cell measurement, when in the normal state when a serving cell measurement meets a criteria.

### TECHNICAL FIELD

This application relates generally to wireless communication systems, including RRM measurements with a wake up signal.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a UE comprising LR and MR modules in accordance with some embodiments.

FIG. 2 illustrates a signal flow diagram of a two-level cell measurement model when the UE is initially in a deep sleep state in accordance with some embodiments.

FIG. 3 illustrates a signal flow diagram of a two-level cell measurement model when the UE is initially in a normal state in accordance with some embodiments.

FIG. 4 illustrate signal flow diagrams of a one-level cell measurement (based on WUS) model when the UE is initially in a deep sleep state in accordance with some embodiments.

FIG. 5 illustrates a signal flow diagram of a one-level cell measurement model when the UE is initially in a normal state in accordance with some embodiments.

FIG. 6 illustrates a signal flow diagram of a one-level cell measurement model based on SSB/CSI-RS in accordance with some embodiments.

FIG. 7 illustrates a signal flow diagram for WUS based measurement for measurement relaxation in accordance with some embodiments.

FIG. 8 illustrates a flowchart of a method for a UE according to embodiments herein.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Two goals of a wireless communication systems is to reduce power consumption and reduce latency. In some embodiments, to reduce UE power consumption, discontinuous reception (DRX) cycle with a large value may be used to enlarge the UE battery life. The large value DRX cycle may be referred to as an extended DRX (eDRX). Extended DRX allows the UE to stay in a low power state for extended periods of time by reducing the frequency at which the UE communicates with the network. An IDLE/INACTIVE UE may be only required to wake up once per DRX cycle for paging monitoring, and Radio Resource Management (RRM) measurement.

However, the eDRX mechanism cannot always meet requirements of both long battery life and low latency. The longer the DRX cycle, the more UE power consumption is reduced, but a longer service delay is introduced. The extended periods between two consecutive network connection attempts may introduce latency that is higher than desirable.

Accordingly, it may be desirable to introduce functions that wake up the UE when the UE is paged by the network node. By waking up when paged, UE power consumption could be dramatically reduced while maintaining a low latency. This can be achieved by using a wake-up signal (WUS) to trigger the main radio (MR) and a separate receiver which has the ability to monitor wake-up signal with ultra-low power consumption. The main radio works for data transmission and reception, which can be turned off or set to deep sleep unless it is turned on.

For example, a UE may use a Low Power Wake-Up Radio (LP-WUR) also referred to herein as LR. LP-WUR is a feature that enables a UE in a wireless network to save power by remaining in a deep sleep state until receiving the wake-up signal to this UE or the UE group to which this UE belongs is received. When the UE's wake-up signal is detected, the UE wakes up to establish a connection with the network using a main radio to transmit or receive data, and then returns to its deep power state.

LP-WUR is particularly useful for Internet of Things (IoT) devices, which may need to transmit small amount of data sporadically and conserve battery life as much as possible. By using LP-WUR, these devices can remain in a deep sleep state for extended periods, conserving energy until they need to transmit or receive data.

A number of power saving schemes are supported in 3GPP. In 3GPP release 15, connected mode DRX (C-DRX) for CONNECTED state, and idle mode DRX (I-DRX) for IDLE/INACTIVE state were introduced. In 3GPP release 16, WUS for DRX active time control in CONNECTED state was introduced. A new DCI was introduced to indicate whether the UE needs to wake up per DRX on duration. If the new UE indicates the UE does not need to wake up, the UE will not wake up during the associated DRX on duration period. Additionally, in release 16, RRM measurement relaxation in IDLE/INACTIVE state was introduced. The UE can relax the RRM measurement for IDLE/INACTIVE mobility if the UE is in low mobility state, or the UE is not in the cell edge.

In 3GPP release 17, paging optimization (Permanent Equipment Identifier (PEI) and paging subgrouping) where introduced. PEI is a DCI to inform UE whether there is actual paging transmission in the associated paging occasion (PO). For paging subgrouping, the UE is further divided into paging subgrouping, and paging subgrouping info is carried in the paging scheduling info. In release 17, Radio Link Monitoring (RLM) and beam failure detection (BFD) relaxation in CONNECTED state were introduced. Further, eDRX mechanism was introduced where the DRX cycle is {2.56 sec, 5.12 s, 10.24 s, 20.48 s, . . . , 1024×1024 (2.91 hrs)}.

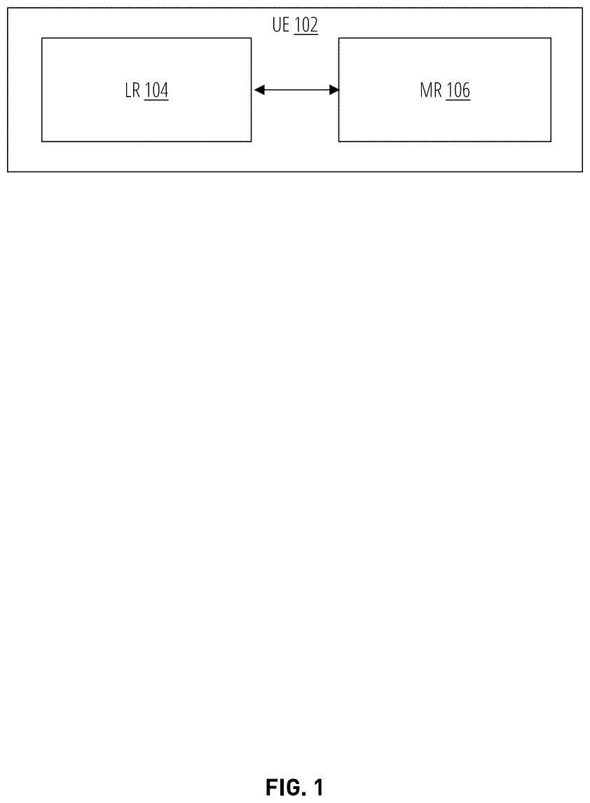

FIG. 1 illustrates a UE 102 comprising LR 104 and MR 106 modules in accordance with some embodiments. The LR 104 enables the UE 102 to save power by remaining in a deep sleep state until it receives a wake-up signal. When the wake-up signal is detected, the UE 102 may return to a normal state and use the MR to communicate with a network node. A low-power wake-up signal for an LR 104 may be used for power-sensitive, small form-factor devices including IoT use cases (such as industrial sensors, controllers) and wearables, extended reality (XR) devices, smart glasses, and smart phones.

The hardware modules may include the MR 106 and a separate LR 104. The MR 106 may be a transmitting and receiving module operating for new radio (NR) signals and channels apart from signals and channel related to the low-power wake-up. The LR 104 may be a receiving module operating for receiving and processing the signals and channel related to low-power wake-up signal. The MR 106 and LR 104 may support multiple RRC states. Both RRC IDLE/INACTIVE and CONNECTED states may be studied as part of the low power (LP) WUS.

For mobility purposes, the UE may perform an RRM measurement in an RRC_CONNECTED, IDLE, and INACTIVE states. An RRM measurement may be classified in four measurement types. A first measurement type includes intra-frequency NR measurements. A second measurement type includes inter-frequency NR measurements. A third measurement type includes inter-Radio Access Technology (RAT) measurements for evolved universal terrestrial radio access (E-UTRA). A fourth measurement type includes inter-RAT measurements for UTRA.

For RRM measurements for an IDLE/INACTIVE UE, the following may apply. The UE may make measurements of attributes of the serving and neighbor cells to enable the reselection process. The UE may operate on the RRM measurement for neighbor cell based on the frequency priority. For the frequency with high priority, the UE performs measurement on that frequency regardless of serving cell's quality. For the frequency with same or lower priority, the UE starts the measurement on that frequency when the serving cell's quality is less than a threshold. An IDLE/INACTIVE UE may perform the RRM measurement based on the synchronization signal block (SSB) per idle discontinuous reception (I-DRX) cycle.

For RRM measurements for a CONNECTED UE, the following may apply. The UE can perform a measurement according to the measurement configuration provided by the network via a UE dedicated RRC signaling, and report the measurement result according to the measurement configuration to the network via an RRC measurement report.

The UE can perform the measurement on serving cells, but may start the measurement on neighbor cell/frequency when the current serving cell's quality is less than a threshold (i.e. S-measure). A CONNECTED UE may perform the RRM measurement based on the SSB/CSI-RS per connected mode DRX (C-DRX) cycle.

However, the problem with the RRM measurement configuration is that with the LP-WUS introduction, the UE may turn off the main radio (NR) and it's possible that the UE does not monitor the reference signaling (i.e. SSB/CSIRS) for RRM measurements when there is no UE activity in the Uu interface.

Without the legacy RRM measurement, there will be some problems for the UE with the LP-WUS configuration to support mobility. Without the RRM measurement on the serving cell, the UE cannot identify whether a current serving cell can work well, resulting in a lack of network when the UE later wants to send data.

Some embodiments herein provide enhancements to the RRM measurement when the LP-WUS is configured. Some embodiments herein may use LP-WUS to save the UE power while ensuring the mobility performance is not affected.

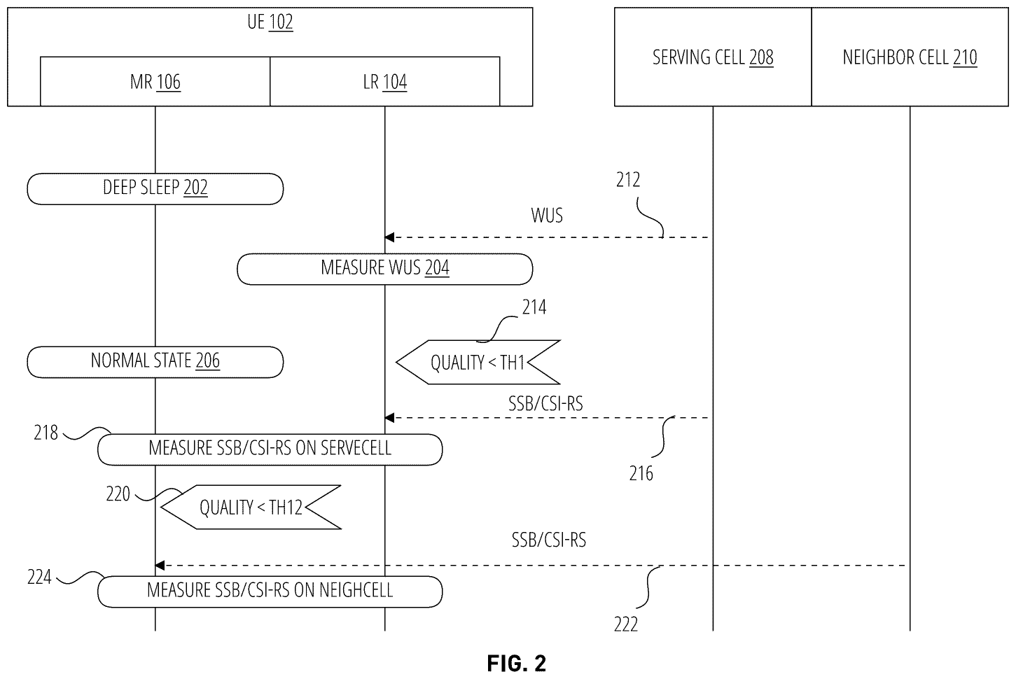

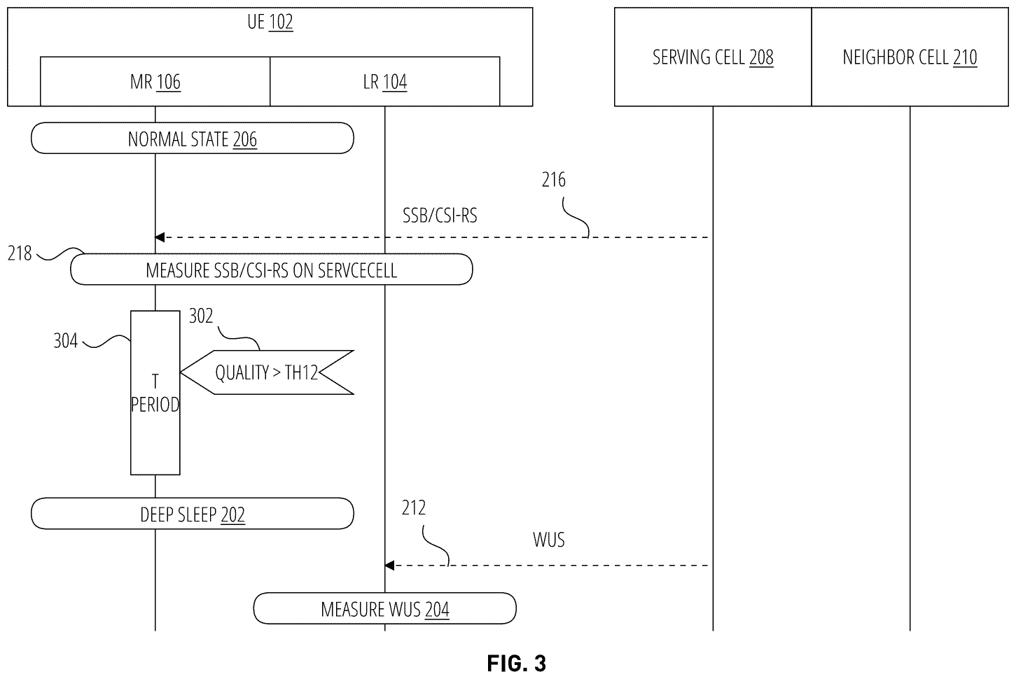

In some embodiments, the UE 102 may use a two-level cell measurement model for the RRM measurement. For the serving cell measurement, if the UE 102 is in a deep sleep state (i.e., MR 106 off and LR 104 on), the UE 102 may perform a serving cell measurement based on a WUS (e.g., LP-WUS) transmitted by the network node. If the WUS quality is less than a threshold, the UE 102 may leave a deep sleep state. When the UE 102 is not in a deep sleep state (i.e., MR 106 on), the UE 102 may perform the serving cell measurement based on the SSB/CSI-RS. For neighbor cell measurements, when the SSB/CSI-RS based quality is less than a threshold, the UE may start the measurement on the neighbor cell. FIG. 2 and FIG. 3 illustrate signal flow diagrams of a two-level cell measurement model in accordance with some embodiments.

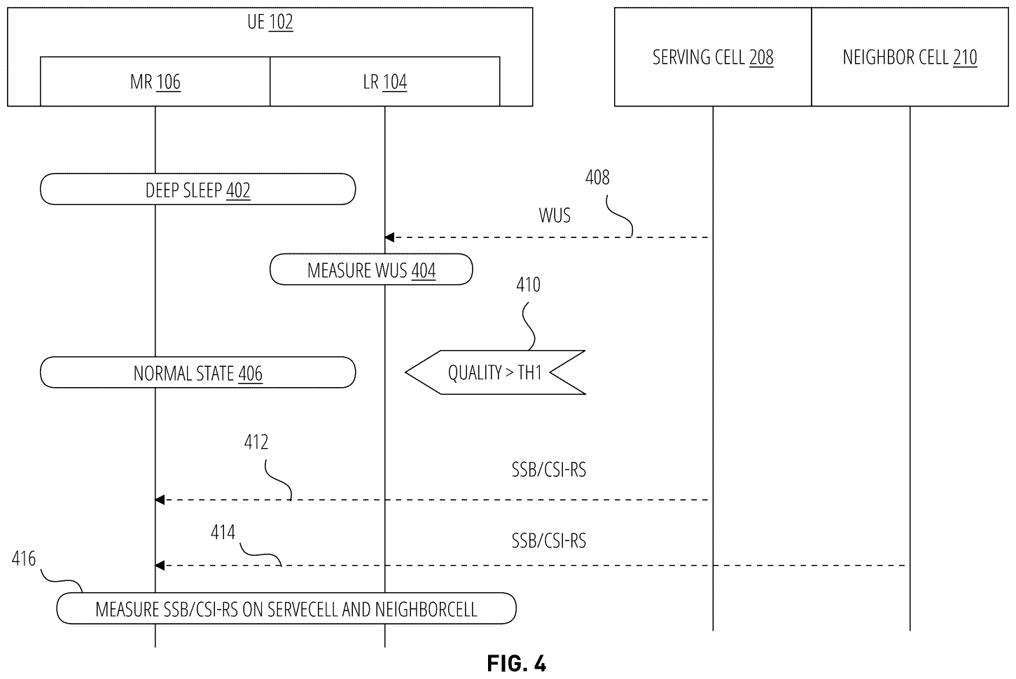

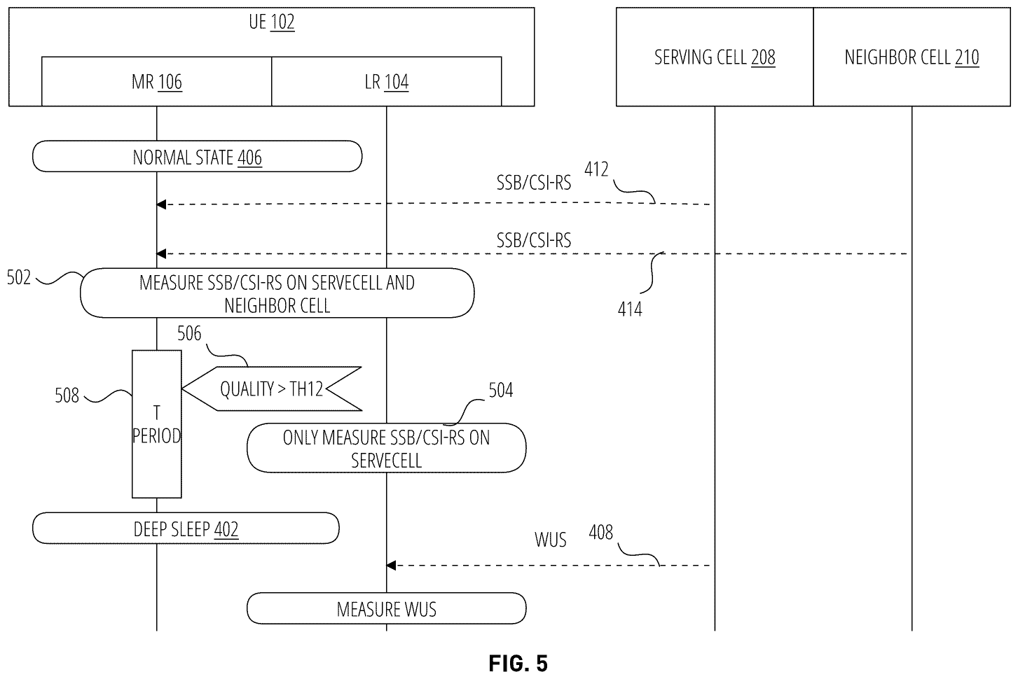

In some embodiments, the UE 102 may use a one-level cell measurement model (based on WUS in deep sleep state) for the RRM measurement. For the serving cell measurement, if the UE 102 is in a deep sleep state, the UE 102 may perform the serving cell measurement based on the LP-WUS. If the UE 102 is not in a deep sleep state, the UE 102 may perform the serving cell measurement based on the SSB/CSI-RS. The neighbor cell measurement may be initiated when serving cell's quality is less than a threshold. A serving cell's quality may be based on a WUS or based on the SSB/CSI-RS. The threshold to enable neighbor measurement may be different for the quality based on different quantity. FIG. 4 and FIG. 5 illustrate signal flow diagrams of a one-level cell measurement (based on WUS) model in accordance with some embodiments.

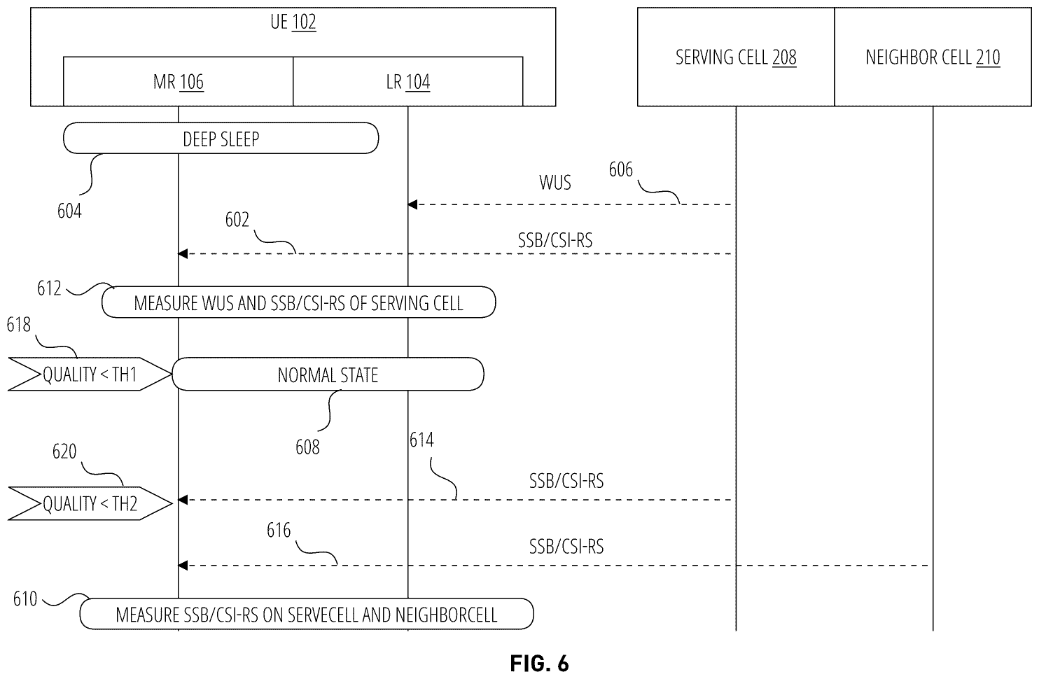

In some embodiments, the UE 102 may use a one-level cell measurement model (based on SSB/CSI-RS) for the RRM measurement. For the serving cell measurement, if the UE 102 is in a deep sleep state, the UE 102 may perform the serving cell measurement based on the SSB/CSI-RS with a long DRX cycle. The neighbor cell measurement may be initiated when a serving cell's quality is less than the threshold. FIG. 6 illustrates a signal flow diagram of a one-level cell measurement (based on SSB/CSI-RS) model in accordance with some embodiments.

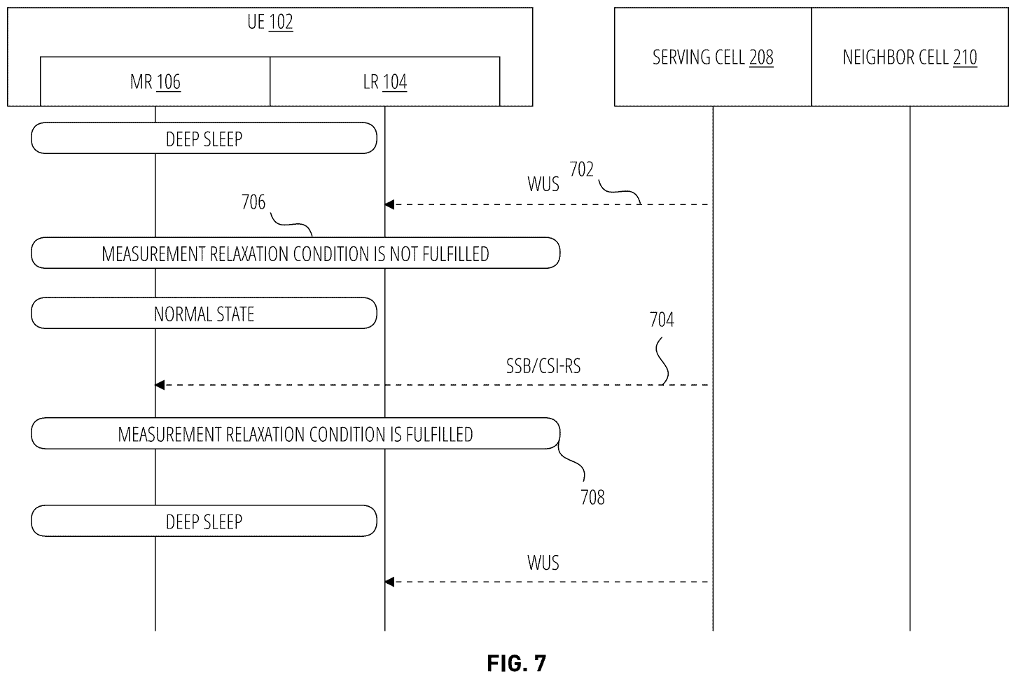

In some embodiments, the UE 102 may use a measurement based on WUS (e.g., LP-WUS) or based on SSB/CSIRS based on whether a measurement relaxation condition is fulfilled or not. A measurement relaxation mechanism may rely on a first condition where the change of serving cell quality is less than threshold within a period; and/or a second condition where the UE's radio quality is less than a threshold. If the measurement relaxation condition is fulfilled, the UE 102 may perform the measurement based on the WUS, otherwise, the UE 102 measurement may be based on the SSB/CSI-RS. FIG. 7 illustrates a measurement based on WUS or based on SSB/CSI-RS based on whether a measurement relaxation condition is fulfilled or not.

FIG. 2 illustrates a signal flow diagram of a two-level cell measurement model when the UE 102 is initially in a deep sleep state 202 in accordance with some embodiments. In the deep sleep state 202, the MR 106 is turned off and the LR 104 is turned on. The UE 102 may be provided a configuration for a wake up signal (WUS 212).

The UE 102 monitors a WUS 212 according to the configuration via the LR 104. The UE 102 may perform a measurement 204 based on the WUS 212 to determine the signal quality from the serving cell 208. In some embodiments, the UE 102 may just perform the WUS measurement per WUS occasion.

The UE 102 evaluates the WUS quality (as determined by the measurement 204). If the WUS quality is greater than a WUS-threshold, the UE 102 still stays in the deep sleep state 202. If the WUS quality is less than a WUS-threshold, the UE 102 leaves the deep sleep state 202. For example, in the illustrated embodiment, the MR 106 enters a normal state 206 when the UE 102 determines 214 that the quality of WUS is less than a first threshold (TH1).

In the normal state 206, the UE 102 turns on the MR 106 to monitor the SSB/CSIRS 216 from the serving cell 208. The MR 106 receives the SSB/CSI-RS 216 and the UE 102 measures 218 the SSB/CSI-RS 216 on the serving cell 208. When the serving cell's quality (as determined by the SSB/CSI-RS measurement) is less than a reference signal (RS)-threshold 220, the UE 102 may start the neighbor cell measurement. The UE 102 may monitor the SSB/CSI-RS 222 from the neighbor cell 210 via the MR 106, and measure 224 the SSB/CSI-RS on the neighbor cell 210.

The SSB/CSI-RS may be used to determine the suitability of a handover. For example, the UE 102 may report the SSB/CSI-RS measurement and the network may make a decision on whether it will let UE 102 perform a handover based on the measurement value from UE 102.

FIG. 3 illustrates a signal flow diagram of a two-level cell measurement model when the UE 102 is initially in a normal state 202 in accordance with some embodiments. In the normal state 206, the MR 106 is turned on. The UE 102 may monitor, via the MR 106, the SSB/CSIRS 216 from the serving cell 208. The MR 106 receives the SSB/CSI-RS 216 and the UE 102 measures 218 the SSB/CSI-RS 216 on the serving cell 208.

Based on the SSB/CSI-RS, the UE 102 may determine to measure the signal quality of the neighbor cell 210 or return to the deep sleep state 202. When the serving cell's quality (as determined by the SSB/CSI-RS measurement) is less than a reference signal (RS)-threshold, the UE 102 may start the neighbor cell measurement. Further, when the serving cell's quality is greater than a RS-threshold (e.g., threshold 302) for some time (e.g., configured period 304) and there is no UE activity, the UE 102 may go back to a deep sleep state 202. The configured period 304 may be a duration of time configured by a network node or as defined in a 3GPP specification.

In the deep sleep state 202, the MR 106 is turned off. The UE 102 may monitor and perform a measurement 204 on the WUS 212 via the LR 104. As shown in FIG. 2, the UE 102 may return to the normal state to once again measure the SSB/CSI-RS of the serving cell 208 and potentially the SSB/CSI-RS of the neighbor cell 210 based on how the WUS 212 compares to a threshold. This cycle of going between a deep sleep state 202 and a normal state 206 may continue to reduce the power consumption of the UE 102 and monitor signal quality.

FIG. 4 illustrate signal flow diagrams of a one-level cell measurement (based on WUS) model when the UE 102 is initially in a deep sleep state 402 in accordance with some embodiments. In the deep sleep state 402 the MR 106 is turned off and the LR 104 is turned on. The UE 102 may be provided a configuration for a wake up signal (WUS 408).

The UE 102 monitors a WUS 408 according to the configuration via the LR 104. The UE 102 may perform a measurement 404 based on the WUS 408 to determine the signal quality from the serving cell 208. In some embodiments, the UE 102 may just perform the WUS measurement per WUS occasion.

The UE 102 evaluates the WUS quality (as determined by the measurement 404). If the WUS quality is greater than a WUS-threshold, the UE 102 still stays in the deep sleep state 402. If the WUS quality is less than a WUS-threshold, the UE 102 leaves the deep sleep state 402. For example, in the illustrated embodiment, the MR 106 enters a normal state 406 when the UE 102 determines 410 that the quality of WUS 408 is less than a first threshold (TH1).

In the normal state 406, the UE 102 turns on the MR 106 to measure 416 the SSB/CSI-RS 412 of the serving cell 208 and the SSB/CSI 414 of the neighbor cell 210. In the illustrated embodiment, the UE 102 performs the serving cell measurement and the neighbor cell measurement at the same time. The measurement DRX cycle may be as defined in legacy methods. When the serving cell's quality is greater than an RS-threshold, the UE 102 may stop the neighbor cell measurement.

In some embodiments, when the serving cell's quality is greater than the RS-threshold for some time (configured period) and there is no UE activity, the UE 102 may go back to a deep sleep state and performs the serving cell measurement based on the WUS (as shown in FIG. 5). In some embodiments, when the serving cell's quality is greater than the RS-threshold for some time (configured period) and there is no UE activity, the UE 102 may stay in a normal state and performs the serving cell measurement based on the SSB/CSI-RS.

FIG. 5 illustrates a signal flow diagram of a one-level cell measurement model when the UE 102 is initially in a normal state 202 in accordance with some embodiments. In the normal state 406, the MR 106 is turned on. The UE 102 may monitor and measure 502, via the MR 106, the SSB/CSI-RS 412 from the serving cell 208 and the SB/CSI-RS 414 from the neighbor cell 210.

When the serving cell's quality is greater than a RS-threshold, the UE 102 may stop neighbor cell measurement. The UE 102 may continue to measure 504 SSB/CSI-RS 412 from the serving cell 208. When the serving cell's quality is greater than an RS-threshold (e.g., threshold 506) for some time (e.g., configured period 508) and there is no UE activity, the UE may have two options.

In a first option, the UE 102 may go back to a deep sleep state 402. In the deep sleep state 402, the MR 106 is turned off. The UE 102 may monitor and perform a measurement on the WUS 408 via the LR 104. As shown in FIG. 4, the UE 102 may return to the normal state to once again measure the SSB/CSI-RS of the serving cell 208 and potentially the SSB/CSI-RS of the neighbor cell 210 based on how the WUS 408 compares to a threshold. This cycle of going between a deep sleep state 402 and a normal state 406 may continue to reduce the power consumption of the UE 102 and monitor signal quality.

In a second option, the UE 102 may stay in the normal state, and perform serving cell measurement based on SSB/CSI-RS 412.

FIG. 6 illustrates a signal flow diagram of a one-level cell measurement model based on SSB/CSI-RS 602 in accordance with some embodiments. In the illustrated embodiment, when the UE 102 is in a deep sleep state 604, the UE 102 monitors the WUS 606 according to a configuration.

Also, while in the deep sleep state 604, the UE 102 may perform measurements 612 based on the SSB/CSI-RS 602 of the serving cell 208, but with a long DRX cycle for the measurement. It may be noted that the measurement requirement/cycle may follow the measurement in eDRX or the measurement requirement for measurement relaxation. When the measurement of the serving cell 208 is less than a first threshold 618, the UE 102 may leave the deep sleep state and enter a normal state 608 with the MR 106 on.

When the UE 102 leaves the deep sleep state, the UE 102 measures 610 the SSB/CSI-RS 614 of the serving cell 208 and SSB/CSI-RS 616 of the neighbor cell. The measurement DRX cycle may be set as within legacy methods. When the serving cell measurement is less than a second threshold 620, the UE 102 may start the neighbor cell measurement. It may be noted that the first threshold 618 and the second threshold 620 may be same or different. When the serving cell's quality is greater than a RS-threshold, the UE 102 may stop the neighbor cell measurement. When the serving cell's quality is greater than the RS-threshold for some time (e.g., a configured period) and there is no UE activity, the UE may have two options.

In a first option, the UE 102 may go back to deep sleep state, and perform serving cell measurement based on SSB/CSI-RS with long DRX cycle. In a second option, the UE 102 may stay in normal state, and perform serving cell measurement based on SSB/CSI-RS.

FIG. 7 illustrates a signal flow diagram for WUS based measurement for measurement relaxation in accordance with some embodiments. The UE 102 may monitor certain measurement relaxation conditions to determine if the RRM measurement may be based on WUS 702 or on SSB/CSI-RS 704. If the measurement relaxation condition is fulfilled, the UE 102 may perform the measurement based on the WUS 702, otherwise the UE 102 may perform the measurement using the SSB/CSI-RS 704.

For example, as shown, when the UE 102 is in a deep sleep state, The UE 102 may monitor and measure the WUS 702. When the UE determines that a measurement relaxation condition is not fulfilled 706, the UE 102 enters a normal state and measures the SSB/CSI-RS 704. When the measurement relaxation condition is fulfilled 708, the UE enters a deep sleep state and begins to perform signal quality measurements using the WUS 702.

Some embodiments may contain one or more measurement relaxation conditions. A first measurement relaxation condition may be that the change of serving cell quality is less than a threshold within a period of time. A second measurement relaxation condition may be that the UE's radio quality is less than a threshold.

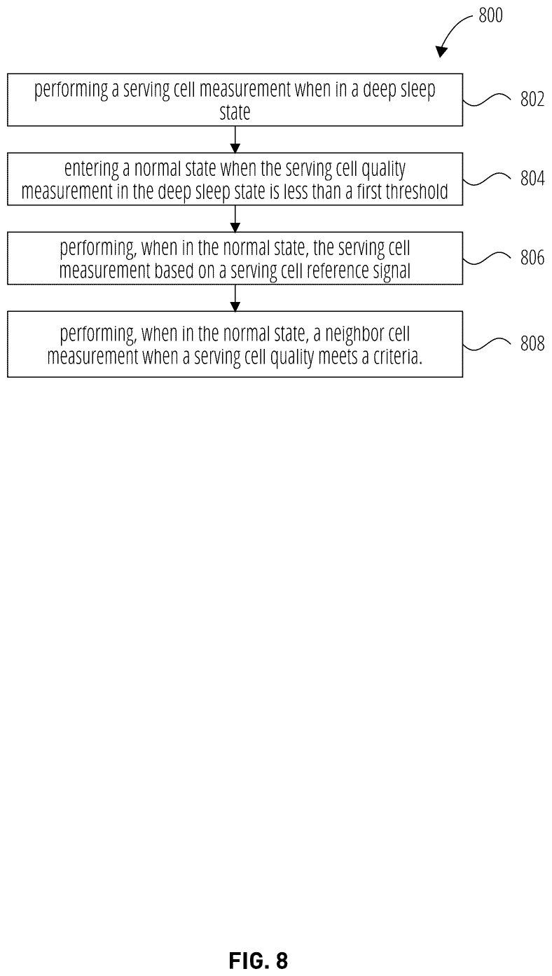

FIG. 8 illustrates a flowchart of a method 800 for a UE according to embodiments herein. The method 800 includes when in a deep sleep state, performing 802 a serving cell measurement. The method 800 further includes entering 804 a normal state when the serving cell quality measurement in the deep sleep state is less than a first threshold. The method 800 further includes performing 806, when in the normal state, the serving cell measurement based on a serving cell reference signal. The method 800 further includes performing 808, when in the normal state, a neighbor cell measurement when a serving cell quality meets a criteria.

In some embodiments, the method 800 further comprises performing the serving cell measurement when in the deep sleep state comprises measuring the serving cell quality based on the wake up signal (WUS).

In some embodiments of the method 800, the neighbor cell measurement is performed in the normal state when the serving cell quality based on a WUS measurement is less than a second threshold.

In some embodiments of the method 800, the serving cell measurement based on the serving cell reference signal is performed in the normal state when the radio quality based on a WUS measurement is less than a third threshold, and wherein the neighbor cell measurement is performed in the normal state when the serving cell quality based on the serving cell reference signal (SSB or CSI-RS) measurement is less than a fourth threshold, wherein the serving cell reference signal comprises a synchronization signal block (SSB) or a channel state information reference signal (CSI-RS).

In some embodiments, the method 800 further returning to the deep sleep state when the serving cell quality is greater than a fifth threshold for a preconfigured or configured period of time and there is no UE activity.

In some embodiments of the method 800, the serving cell measurement is based on WUS or based on a serving cell SSB or a serving cell CSI-RS and is used to determine when the serving cell quality meets the criteria to initiate the neighbor cell measurement.

In some embodiments of the method 800, the criteria to enable neighbor measurement comprises a different threshold for when the WUS is used then when the serving cell SSB or the serving cell CSI-RS is used.

In some embodiments, the method 800 further comprises further comprising determining if a measurement relaxation condition is fulfilled, wherein when the measurement relaxation condition is fulfilled, the serving cell measurement is based on WUS when the UE is in the deep sleep state, and wherein when the measurement relaxation condition is not fulfilled, the serving cell measurement is based on a serving cell SSB or a serving cell CSI-RS when the UE is in the normal state.

In some embodiments of the method 800, the measurement relaxation condition is fulfilled when a change of serving cell quality is less than a second threshold within a preconfigured period, or a UE radio quality is less than a third threshold.

In some embodiments of the method 800, measuring the serving cell quality when in the deep sleep state comprises performing the serving cell measurement based on a serving cell SSB or a serving cell CSI-RS with long discontinuous reception (DRX) cycle or long measurement cycle.

Embodiments contemplated herein include an apparatus comprising means to perform one or more elements of the method 800. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 800. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1002 that is a UE, as described herein).

Embodiments contemplated herein include a signal as described in or related to one or more elements of the method 800.

Note that thresholds described in the embodiments herein may be the same or different. For instance, a second threshold may be the same as or different from a first threshold.

Embodiments contemplated herein include a computer program or computer program product comprising instructions, wherein execution of the program by a processor is to cause the processor to carry out one or more elements of the method 800. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

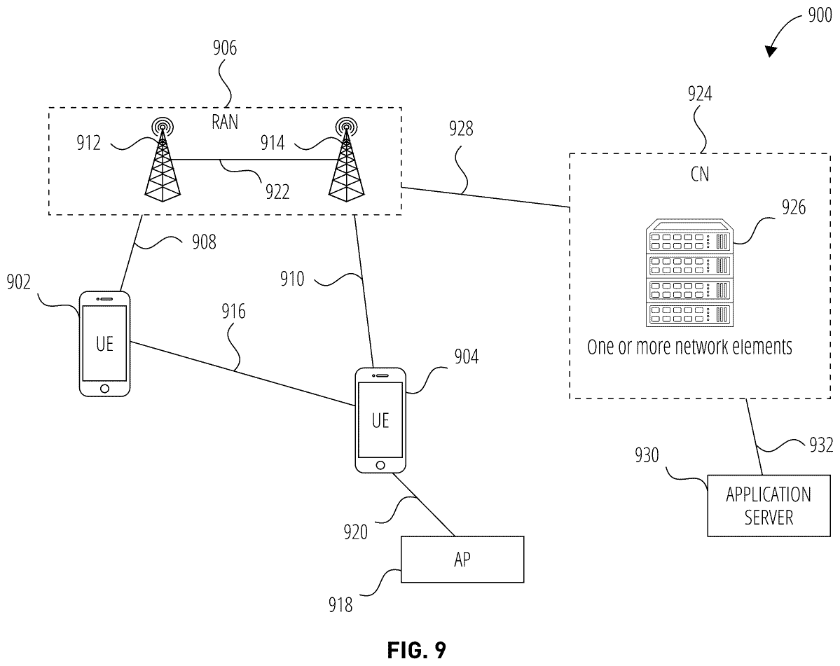

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VOIP sessions, group communication sessions, etc.) for the UE 902 and UE 904 via the CN 924. The application server 930 may communicate with the CN 924 through an IP communications interface 932.

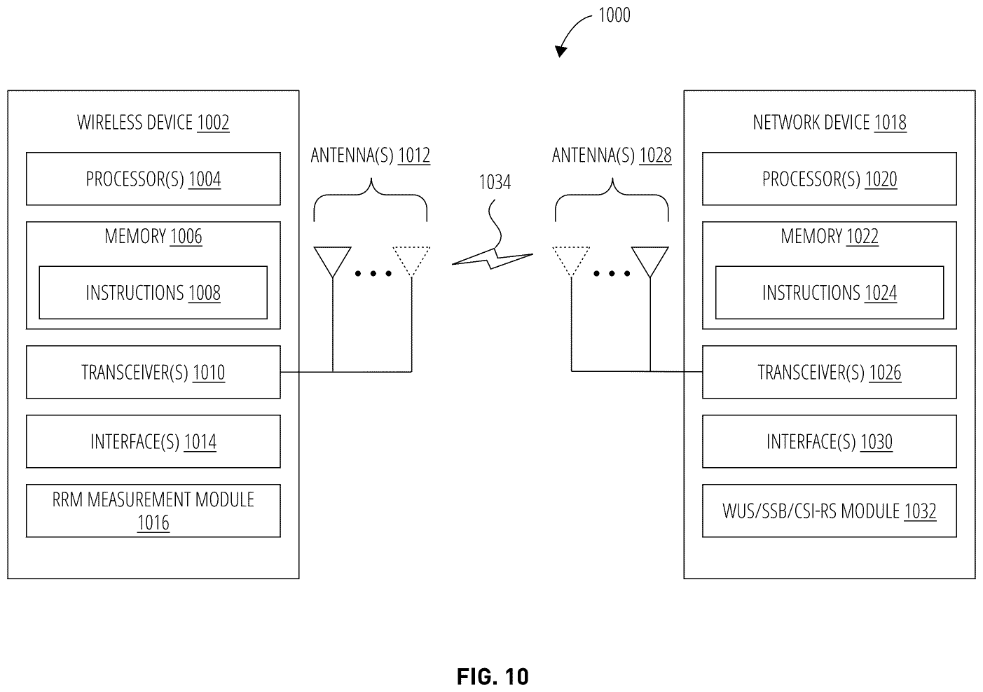

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter circuitry and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include an RRM measurement module 1016. The RRM measurement module 1016 may be implemented via hardware, software, or combinations thereof. For example, the RRM measurement module 1016 may be implemented as a processor, circuit, and/or instructions 1008 stored in the memory 1006 and executed by the processor(s) 1004. In some examples, the RRM measurement module 1016 may be integrated within the processor(s) 1004 and/or the transceiver(s) 1010. For example, the RRM measurement module 1016 may be implemented by a combination of software components (e.g., executed by a DSP or a general processor) and hardware components (e.g., logic gates and circuitry) within the processor(s) 1004 or the transceiver(s) 1010.

The RRM measurement module 1016 may be used for various aspects of the present disclosure, for example, aspects of FIGS. 1-9. The RRM measurement module 1016 is configured to perform RRM measurements based on WUS or SSB/CSI-RS.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter circuitry and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include a WUS/SSB/CSI-RS module 1032. The WUS/SSB/CSI-RS module 1032 may be implemented via hardware, software, or combinations thereof. For example, the WUS/SSB/CSI-RS module 1032 may be implemented as a processor, circuit, and/or instructions 1024 stored in the memory 1022 and executed by the processor(s) 1020. In some examples, the WUS/SSB/CSI-RS module 1032 may be integrated within the processor(s) 1020 and/or the transceiver(s) 1026. For example, the WUS/SSB/CSI-RS module 1032 may be implemented by a combination of software components (e.g., executed by a DSP or a general processor) and hardware components (e.g., logic gates and circuitry) within the processor(s) 1020 or the transceiver(s) 1026.

The WUS/SSB/CSI-RS module 1032 may be used for various aspects of the present disclosure, for example, aspects of FIGS. 1-9. The WUS/SSB/CSI-RS module 1032 is configured to transmit a WUS signal or SSB/CSI-RS signal to the wireless device 1002.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
when in a deep sleep state, performing a serving cell measurement;
entering a normal state when the serving cell measurement in the deep sleep state is less than a first threshold; and
performing, when in the normal state, the serving cell measurement based on a serving cell reference signal;
performing, when in the normal state, a neighbor cell measurement when a serving cell quality meets a criteria.

2. The method of claim 1, wherein performing the serving cell measurement when in the deep sleep state comprises measuring the serving cell quality based on a wake up signal (WUS).

3. The method of claim 2, wherein the neighbor cell measurement is performed in the normal state when the serving cell quality based on a WUS measurement is less than a second threshold.

4. The method of claim 2, wherein the serving cell measurement based on the serving cell reference signal is performed in the normal state when a radio quality based on a WUS measurement is less than a third threshold, and
wherein the neighbor cell measurement is performed in the normal state when the serving cell quality based on the serving cell reference signal measurement is less than a fourth threshold, wherein the serving cell reference signal comprises a synchronization signal block (SSB) or a channel state information reference signal (CSI-RS).

5. The method of claim 1, further comprising returning to the deep sleep state when the serving cell quality is greater than a fifth threshold for a preconfigured or configured period of time and there is no UE activity.

6. The method of claim 1, wherein the serving cell measurement is based on WUS or based on a serving cell synchronization signal block (SSB) or a serving cell channel state information reference signal (CSI-RS) and is used to determine when the serving cell quality meets the criteria to initiate the neighbor cell measurement.

7. The method of claim 6, wherein the criteria to enable neighbor measurement comprises a different threshold for when the WUS is used then when the serving cell SSB or the serving cell CSI-RS is used.

8. The method of claim 1, further comprising determining if a measurement relaxation condition is fulfilled,
wherein when the measurement relaxation condition is fulfilled, the serving cell measurement is based on WUS when the UE is in the deep sleep state, and
wherein when the measurement relaxation condition is not fulfilled, the serving cell measurement is based on a serving cell synchronization signal block (SSB) or a serving cell channel state information reference signal (CSI-RS) when the UE is in the normal state.

9. The method of claim 8, wherein the measurement relaxation condition is fulfilled when a change of serving cell quality is less than a second threshold within a preconfigured period, or a UE radio quality is less than a third threshold.

10. The method of claim 1, wherein measuring the serving cell quality when in the deep sleep state comprises performing the serving cell measurement based on a serving cell synchronization signal block (SSB) or a serving cell channel state information reference signal (CSI-RS) with long discontinuous reception (DRX) cycle or long measurement cycle.

11. A user equipment (UE) apparatus comprising:
a processor; and
a memory storing instructions that, when executed by the processor, configure the apparatus to:
when in a deep sleep state, perform a serving cell measurement;
enter a normal state when the serving cell measurement in the deep sleep state is less than a first threshold; and
perform, when in the normal state, the serving cell measurement based on a serving cell reference signal;
perform, when in the normal state, a neighbor cell measurement when a serving cell quality meets a criteria.

12. The UE apparatus of claim 11, wherein performing the serving cell measurement when in the deep sleep state comprises measuring the serving cell quality based on a wake up signal (WUS).

13. The UE apparatus of claim 12, wherein the neighbor cell measurement is performed in the normal state when the serving cell quality based on a WUS measurement is less than a second threshold.

14. The UE apparatus of claim 12, wherein the serving cell measurement based on the serving cell reference signal is performed in the normal state when a radio quality based on a WUS measurement is less than a third threshold, and
wherein the neighbor cell measurement is performed in the normal state when the serving cell quality based on the serving cell reference signal measurement is less than a fourth threshold, wherein the serving cell reference signal comprises a synchronization signal block (SSB) or a channel state information reference signal (CSI-RS).

15. A non-transitory computer-readable storage medium, the computer-readable storage medium including instructions that when executed by a user equipment (UE), cause the UE to:
when in a deep sleep state, perform a serving cell measurement;
enter a normal state when the serving cell measurement in the deep sleep state is less than a first threshold; and
perform, when in the normal state, the serving cell measurement based on a serving cell reference signal;
perform, when in the normal state, a neighbor cell measurement when a serving cell quality meets a criteria.

16. The computer-readable storage medium of claim 15, wherein the serving cell measurement is based on WUS or based on a serving cell synchronization signal block (SSB) or a serving cell channel state information reference signal (CSI-RS) and is used to determine when the serving cell quality meets the criteria to initiate the neighbor cell measurement.

17. The computer-readable storage medium of claim 16, wherein the criteria to enable neighbor measurement comprises a different threshold for when the WUS is used then when the serving cell SSB or the serving cell CSI-RS is used.

18. The computer-readable storage medium of claim 15, wherein the instructions further configure the UE to determine if a measurement relaxation condition is fulfilled,
wherein when the measurement relaxation condition is fulfilled, the serving cell measurement is based on WUS when the UE is in the deep sleep state, and
wherein when the measurement relaxation condition is not fulfilled, the serving cell measurement is based on a serving cell synchronization signal block (SSB) or a serving cell channel state information reference signal (CSI-RS) when the UE is in the normal state.

19. The computer-readable storage medium of claim 18, wherein the measurement relaxation condition is fulfilled when a change of serving cell quality is less than a second threshold within a preconfigured period, or a UE radio quality is less than a third threshold.

20. The computer-readable storage medium of claim 15, wherein measuring the serving cell quality when in the deep sleep state comprises performing the serving cell measurement based on a serving cell synchronization signal block (SSB) or a serving cell channel state information reference signal (CSI-RS) with long discontinuous reception (DRX) cycle or long measurement cycle.
